(19) United States
(12) Patent Application Publication
(10) Pub. No.: US 2012/0317486 A1
(43) Pub. Date: Dec. 13, 2012

(54) EMBEDDED WEB VIEWER FOR PRESENTATION APPLICATIONS

(75) Inventors: Rebecca Meredith Loew, Mountain View, CA (US); Cameron David Kikoen, Mountain View, CA (US); Marcelo Augusto Cardozo, JR., Santa Clara, CA (US); Nina Gholami, San Jose, CA (US)

(73) Assignee: Microsoft Corporation, Redmond, WA (US)

(21) Appl. No.: 13/154,462

(22) Filed: Jun. 7, 2011

(51) Int. Cl. G06F 3/01

(52) U.S. Cl. 715/730

(57) ABSTRACT

Presentation content is embedded within a Web page utilizing a presentation Web Part. The presentation Web Part is configured to create a Web element, such as an inline frame (“iFrame”) within which the presentation content can be displayed. The presentation Web Part is configured with an outer application programming interface (“API”) that functions as a message wrapper, such as a postMessage wrapper, for an inner API to call functions of a presentation Web application to manipulate the presentation content such as by advancing through various slides of the presentation content. For example, the presentation Web Part and a map Web Part may be displayed on the same Web page such that when a user selects a city or other location via the map Web Part, the presentation Web Part displays presentation content associated with the selected location. Other use cases are provided herein.

### BACKGROUND

Software applications such as word processing applications, spreadsheet applications, presentation applications, and the like have traditionally been locally installed on computer systems. Such software applications are typically tied to a particular computer system or group of computer systems upon which the software applications are installed in accordance with various licensing agreements. Aside from the cost of purchasing licenses and installing software applications on multiple computer systems, the need and potential further costs to update applications for bug fixes, security fixes, and other updates can be an impetus for software fragmentation due to some users not updating their software applications as recommended.

As a result of these and other problems, many software applications that were developed for local installation are now being developed, in some cases exclusively, as Web applications. This migration to Web applications allows a software developer to consistently offer an up-to-date version without the concern of software fragmentation. Web applications also afford users a more flexible work environment by permitting users to create, view, and edit content from any computer system with an internet connection and a compatible Web browser. Moreover, Web applications can be offered for free or for a cost that is less than traditional software applications due the reduction of overhead expenses associated with manufacturing, shipping, and stocking disks or other media upon which a software application is stored.

Certain Web applications provide content and functionality using Web Parts. Web Parts are server-side controls that run inside the context of Web pages. Web Parts give users the ability to add functionality to a Web page by simply adding them to the Web page. Web Parts exist that allow a user to add content associated with a particular Web application, however, a Web Part does not exist to add presentation content, such as content created using a native or Web-version of MICROSOFT POWERPOINT, available from Microsoft of Redmond, Wash., to a Web page.

In addition to providing content for display, it is often desirable to manipulate content displayed in one Web Part utilizing another Web Part or other controls on a Web page. For example, it may be desirable to display presentation content in context of other content such as maps, lists, and/or other interactive user interface elements within a page such that when a user selects a place on a map, an item in a list, or otherwise interacts with a user interface element, presentation content is displayed in a meaningful way.

It is with respect to these and other considerations that the disclosure made herein is presented.

### SUMMARY

Concepts and technologies are described herein for embedding presentation content within a Web page utilizes a presentation Web Part. In accordance with the concepts and technologies disclosed herein, a presentation Web Part is configured to create a Web element, such as an inline frame (“iFrame”) within which the presentation content can be displayed. An iFrame is a hypertext markup language (“HTML”) element configured to include an external object such as, as disclosed herein, a viewer by which to display the presentation content.

The presentation Web Part is configured with an outer application programming interface (“API”) that functions as a wrapper, such as a postMessage wrapper, for an inner API to call functions of a presentation Web application to manipulate the presentation content such as by advancing through various slides of the presentation content. The outer API functioning as a wrapper can call a method to allow cooperative information exchange between the outer API and the inner API from different objects embedded within the Web page.

According to one aspect, an iFrame is displayed within a Web page as part of a presentation Web Part and presentation content is displayed within the iFrame. An inner API receives an instruction within a message, such as a postMessage, from an outer API and manipulates the presentation content within the inline frame in accordance with the instruction received by the inner API.

According to another aspect, presentation content is scaled to a plurality of sizes and cached. A request for the presentation content is received and, in response to the request, an appropriate size of the presentation content is retrieved and inserted into a target iFrame.

According to yet another aspect, an iFrame is created in which to display presentation content. A Web application for viewing the presentation content is executed within the iFrame and the presentation content is displayed within the inline frame as a result of executing the Web application.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an exemplary operating environment for the various embodiments disclosed herein.

FIG. 2 is a diagram illustrating a presentation Web Part, according to an exemplary embodiment.

FIG. 3 is a diagram illustrating a settings user interface, according to an exemplary embodiment.

FIG. 4 is a flow diagram showing aspects of a method for executing a Web page that includes a presentation Web part, according to an exemplary embodiment.

FIG. 5 is a flow diagram showing aspects of a method for caching presentation data, according to an exemplary embodiment.

FIG. 6 is a flow diagram showing aspects of a method for selecting a presentation bundle size, according to an exemplary embodiment.

FIG. 7 is a flow diagram showing aspects of a method for calling an implementation of a Web application, according to an exemplary embodiment.

FIG. 8 is a flow diagram showing aspects of a method for communication between an outer application programming interface (“API”) and an application that is calling the outer API, according to an exemplary embodiment.

FIG. 9 is a computer architecture diagram illustrating an exemplary computer hardware and software architecture for a computing system capable of implementing aspects of the embodiments presented herein.

### DETAILED DESCRIPTION

The following detailed description is directed to concepts and technologies for embedding presentation content within a Web page utilizing a presentation Web Part. According to the concepts and technologies described herein, a presentation Web Part is configured to create a Web element, such as an iFrame, within which the presentation content can be displayed. The presentation Web Part is configured with an outer API that functions as a wrapper, such as a postMessage wrapper, for an inner API to call functions of a presentation Web application to manipulate the presentation content such as by advancing through various slides of the presentation content.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodology for embedding presentation content within a Web page utilizing a presentation Web Part will be described, in addition to other aspects.

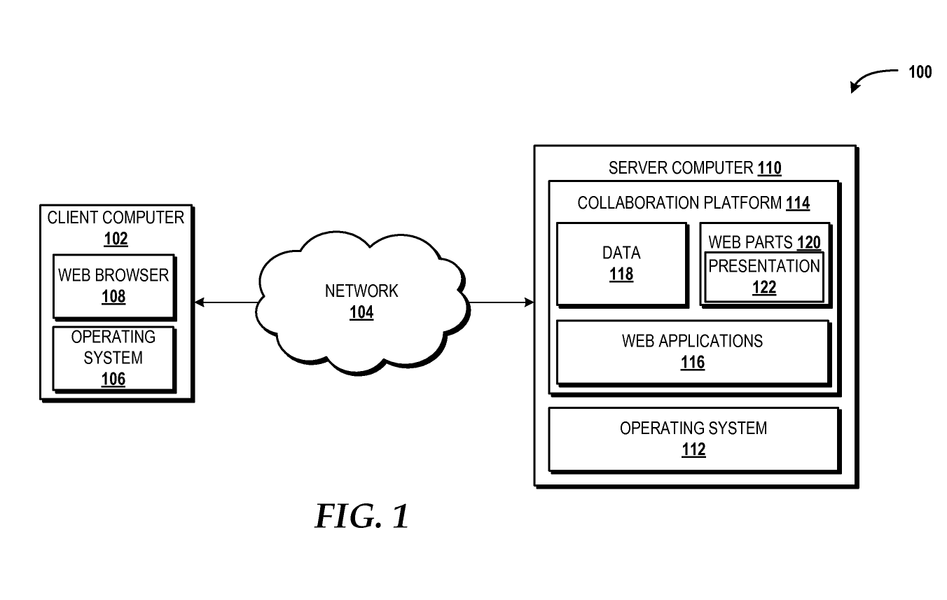

Referring now to FIG. 1, aspects of one operating environment 100 for the various embodiments presented herein will be described. The operating environment 100 includes a client computer 102 operating on or in communication with a network 104. The client computer 102 is configured to execute an operating system 106 and one or more application programs such as, for example, a web browser 108 and/or other application programs.

The operating system 106 is a computer program for controlling the operation of the client computer 102. The application programs are executable programs configured to execute on top of the operating system 106 to provide various functionality described herein. The Web browser 108 is an application program through which a user can access information resources on the World Wide Web (“the Web”) via the network 104. Moreover, the Web browser 108 allows a user to access information and various functionality provided by a server computer 110.

The illustrated server computer 110 is configured to execute an operating system 112 and one or more application programs of a collaboration platform 114 including, for example, one or more Web applications 116 and/or other application programs. The operating system 112 is a computer program for controlling the operation of the server computer 110. The application programs are executable programs configured to execute on top of the operating system 112 to provide various functionality described herein. In particular, the one or more Web applications 116 are application programs accessible by the Web browser 108 over the network 104.

In some embodiments, the Web applications 116 include at least a presentation Web application, but may also include one or more word processing applications, spreadsheet applications, presentation applications, email applications, calendaring applications, drawing applications, and/or other applications accessible by the Web browser 108. For example, the Web applications 116 may include Web-based versions of MICROSOFT WORD, MICROSOFT EXCEL, MICROSOFT POWERPOINT, MICROSOFT OUTLOOK, and/or MICROSOFT VISIO, all of which are available from Microsoft of Redmond, Wash. Alternatively or additionally, the Web applications 116 may include GOOGLE DOCUMENTS, GOOGLE SPREADSHEETS, GOOGLE PRESENTATIONS, GOOGLE MAIL, and/or GOOGLE DRAWINGS, all of which are available from Google of Mountain View, Calif. Other Web applications including social networking applications, photo applications, communication applications (e.g., voice over IP and/or instant messaging), and the like are contemplated.

In some embodiments, the collaboration platform 114 is a centralized host for the Web applications 116. For example, a user of the client computer 102 can access the collaboration platform 114 via the Web browser 108 to create, edit, and/or view content utilizing one or more of the Web applications 116. In some embodiments, the collaboration platform 114 provides collaboration services including, but not limited to, conferencing, instant messaging, email, calendar, and/or collaboration workspaces. Collaboration workspaces, for example, may be used by multiple users to collaborate on the creation or editing of content via the Web applications 116.

In some embodiments, the collaboration platform 114 also provides a storage solution through which users can save content created via the Web applications 116 for later viewing or editing. The collaboration platform 114 may alternatively or additionally be configured to receive content created locally on the client computer 102 for storage at the collaboration platform 114. Content uploaded to the collaboration platform 114, or content created or edited through the Web applications 116, may be stored as data 118 at the server computer 110. The data 118 may be accessed by the client computer 102 and/or other computers (not shown).

The collaboration platform 114, in some embodiments, allows one or more users to create a Website including one or more Web pages. The Website and the one or more Web pages may be included in the data 118 saved on the server computer 110 and accessible via one or more uniform resource locators (“URLs”) via the Web browser 108. The one or more Web pages may include one or more Web Parts 120. The Web Parts 120 are server-side controls that run inside the context of the Web pages within the collaboration platform 114. The Web Parts 120 enable users of the client computer 102 to add functionality to a Web page directly through the browser 108. For example, through the Web Parts 120, a user of the client computer 102 can create or modify content, appearance, and/or behavior of a Web page through the browser 108.

The Web Parts 120 may include default Web Parts that are provided as part of the collaboration platform 114 and/or custom Web Parts created by a user of the client computer 102. In some embodiments, the Web Parts 120 particularly include a presentation Web Part 122 that can be added to a Web page to provide functionality to display presentation content (also referred to as “a presentation bundle” or “a presentation deck”) within a Web page. In some embodiments, the presentation content is formatted as a MICROSOFT POWERPOINT presentation consisting of one or more presentation slides, each of which includes content such as text, images, videos, hyperlinks, animations, games, and/or other interactive or non-interactive elements.

It is contemplated that the presentation content may be displayed by the presentation Web Part 122 in the same manner as the presentation content would be displayed if displayed via a dedicated presentation Web application or a native application running locally on the client computer 102. That is, presentation content such as animations of elements within a slide and/or animations between slides may be maintained through the presentation Web Part 122.

It is also contemplated that the presentation Web Part 122 may interact with one or more other Web Parts of the Web Parts 120 to provide various enhanced functionality to a Web page. For example, the presentation Web Part 122 and a map Web Part may be displayed on the same Web page such that when a user selects a city or other location via the map Web Part, the presentation Web Part 122 displays presentation content associated with the selected location. The presentation content displayed by the presentation Web Part 122 may be a presentation deck including one or more presentation slides associated with the selected location. Alternatively, the presentation content displayed by the presentation Web Part 122 may be a presentation slide associated with the selected location within a presentation deck that includes presentation slides for various locations including the selected location and one or more additional locations. Other uses of the presentation Web Part 122 along with one or more other Web parts are contemplated.

The Web Parts 120 may, in addition to the presentation Web Part 122, include one or more of a list view Web Part used to display and edit list data, a content editor Web part used to add formatted text, tables, hyperlinks, and/or images, a form Web Part used to connect to and filter a column of data displayed within another Web Part, an image Web Part used to add a picture or graphic and adjust (e.g., alignment, background color, etc.) the picture or graphic, a page viewer Web Part used to display a Web page, file, or folder, and an extensible markup language (“XML”) Web Part used to display XML and apply extensible stylesheet language transformations (“XSLT”) to the XML before the content is displayed. Moreover, any of the Web Parts 120 may include pre-set and/or custom settings used to adjust the functionality of the Web Parts 120.

In some embodiments, the collaboration platform 114 is MICROSOFT SHAREPOINT, available from Microsoft of Redmond, Wash. In other embodiments, the collaboration platform 114 is GOOGLE DOCS, available from Google of Mountain View, Calif. In still other embodiments, the collaboration platform 114 is not used and the Web Parts 120 are made available as stand-alone solutions for adding various content to a Web page.

It is contemplated that access to the server computer 110 may be protected by one or more authentication factors such as, but not limited to, ownership factors (e.g., ID card, security token, cell phone, etc.), knowledge factors (e.g., password, pass phrase, personal identification number (“PIN”), challenge response), and/or inherence factors (e.g., fingerprint, retinal pattern, DNA sequence, signature, face recognition, unique bio-electric signals, or other biometric identifiers). Moreover, the same, alternative, or further authentication may be required to access the collaboration platform 114, one or more of the Web applications 116, and/or the data 118.

According to various embodiments, the client computer 102 and/or the server computer 110 are personal computers (“PC”) such as desktop, tablet, or laptop computer systems. The client computer 102 and/or the server computer 110 may include other types of computing systems including, but not limited to, server computers, handheld computers, netbook computers, embedded computer systems, personal digital assistants, mobile telephones, smart phones, or other computing devices.

It should be understood that some implementations of the operating environment 100 include multiple client computers 102, multiple networks 104, and/or multiple server computers 110. It should also be understood that multiple operating systems 106 and/or multiple web browsers 108 may be used by the client computer 102, and multiple operating systems 112 may be used by the server computer 110. Thus, the illustrated embodiments should be understood as being exemplary, and should not be construed as being limiting in any way.

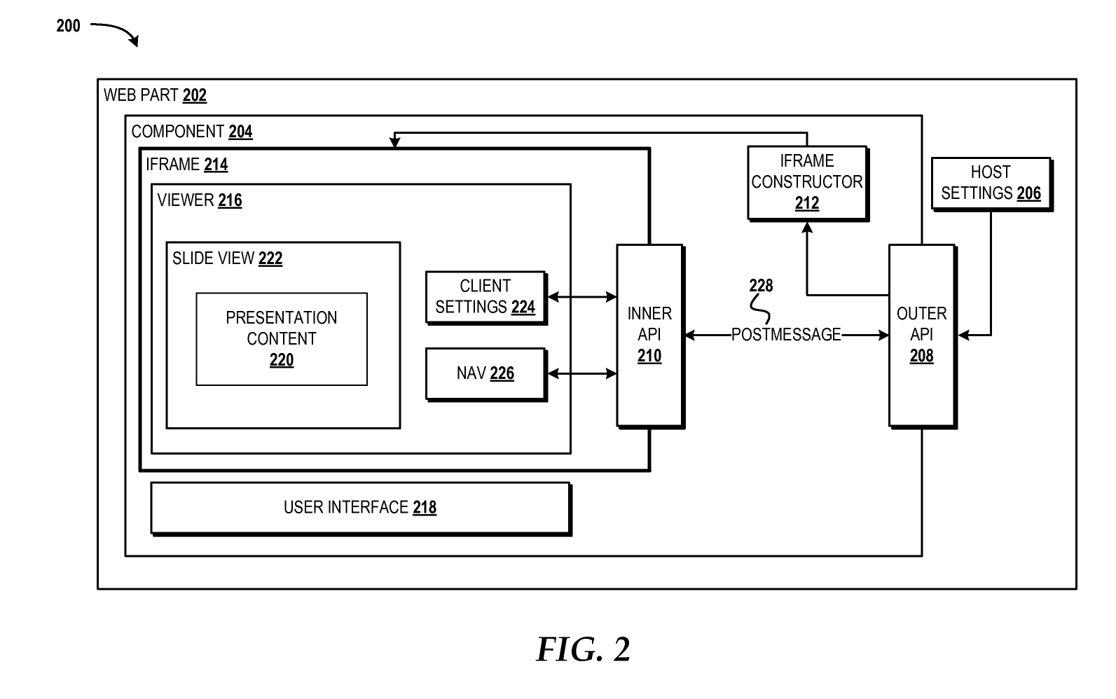

Turning now to FIG. 2, aspects of an exemplary Web Part architecture 200 will be described in detail. The Web Part architecture 200 includes a presentation Web Part 202 (such as the presentation Web Part 122), which in turn includes a core component 204 and one or more host settings 206. In some embodiments, the host settings 206 are settings associated with the collaboration platform 114. In some embodiments, the core component 204 is created such that it can be packaged as a server side rendering (“SSR”) control. In other embodiments, the core component 204 is created such that it can be packaged as a client side rendering (“CSR”) control. For ease of explanation, the core component 204 is considered as an SSR control for the remainder of this disclosure.

The core component 204 includes an outer application programming interface (“outer API”) 208. In some embodiments, the outer API 208 is a postMessage wrapper for an inner API 210. In particular, the outer API 208 may utilize a postMessage to allow cooperative information exchange between the outer API 208 and the inner API 210 from different objects embedded within a Web page. In some embodiments, the outer API 208 and the inner API 210 are written in JavaScript language. The postMessage is a JavaScript function of hypertext markup language version 5 (“HTML5”). The functions of the outer API 208 and the inner API 210 will be described in greater detail herein.

The core component 204 also includes an iFrame constructor 212 that is configured to create an inline frame (“iFrame”) 214. In some embodiments, the iFrame constructor 212 is included as part of the outer API 208. The iFrame 214 created by the iFrame constructor 212 is an HTML element configured to include an external object. The illustrated iFrame 214 is configured to include an external object embodied as a viewer 216.

The illustrated iFrame 214 is associated with a user interface 218 separate from the viewer 216. In some embodiments, the user interface 218 is added by a user (e.g., a Web site developer) to provide various functions on top of the viewer 216. These functions may provide, for example, interactivity with other Web parts on a Web page. The user interface 218 may alternatively include functions to allow a user to display and/or manipulate presentation content 220 included in a slide view 222 of the viewer 216. For example, the user interface 218 may provide buttons or other interactive elements through which a user can play a slide show of the presentation content 220, stop the slide show, pause the slide show, select a next slide, select a previous slide, and view identifying information (e.g., slide X of Y slides) for a currently viewable slide. The presentation content 220 may be sourced from the client computer 102, the data 118, or another location. The inclusion of the user interface 218 may be a design choice and may be custom-designed by or for a particular developer.

It is contemplated that the user interface 218 may be temporarily or permanently hidden from certain views. For example, the user interface 218 may be hidden until a cursor is positioned over an area of a Web page that is associated with the user interface 218, at which point the user interface 218 is revealed. The user interface 218 may alternatively be hidden permanently from all users, or certain users such as those with restricted access (e.g., read-only permissions for the presentation content 220 or for all content of particular Web site or page contained within).

The viewer 216 is also associated with client settings 224 and navigation functions 226. The client settings 224 allow a user to control various functions about the component 204, as will be described in greater detail below., and location of the slide view 222. The navigation functions 226 may be functions to play a slide show of the presentation content 220, stop the slide show, pause the slide show, select a next slide, select a previous slide, and view identifying information (e.g., slide X of Y slides) for a currently viewable slide.

The client settings 224 and the navigation functions 226 are used by the inner API 210 to manipulate the presentation content per requests received by the inner API 210 from the outer API 208 in one or more postMessages 228. For example, the outer API 208 may receive instructions to advance the presentation content 220 to the next slide, and so the outer API 208 generates a postMessage 228 including such instructions and sends the postMessage 228 to the inner API 210, which then calls a function of one of the Web applications 116 (i.e., a presentation Web application) to advance the presentation content 220 to the next slide. Here, the function may be a particular method utilized by the presentation Web application to advance to a next slide. Moreover, any transition or other animations associated with the advancement can be acquired by the inner API 210 by calling an animation library utilized by the presentation Web application.

The client settings 224 may be a subset of the host settings 206. The host settings 206 include, for example, the source of the presentation content 220 (i.e., point to a particular file that includes the presentation content 220), an initial size (e.g., height and width) of the presentation content 220, and controls included in the navigation functions 226. Some of the host settings 206 may also be client settings 224. For example, auto-advance settings may be included in the host settings 206 and in the client settings 224.

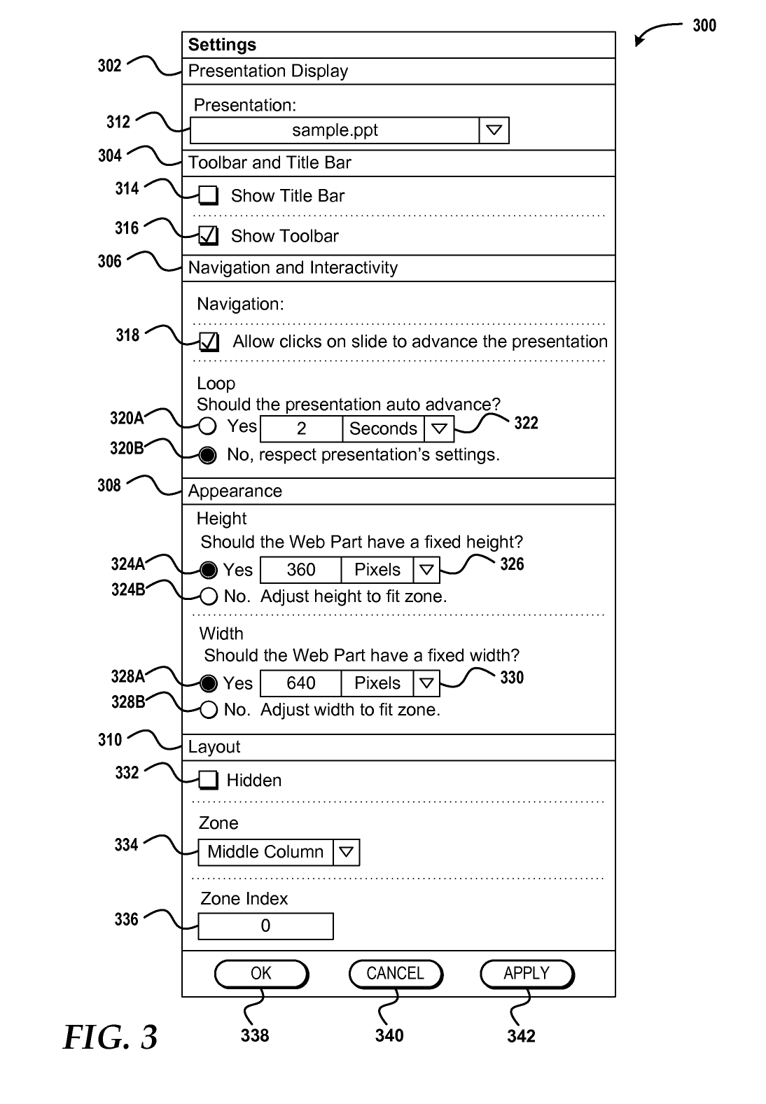

Turning now to FIG. 3, a settings user interface 300 through which a user can select various host settings 206 for the presentation content 220 will be described with further reference to FIGS. 1 and 2. As illustrated, the settings user interface 300 includes a presentation display section 302, a toolbar and title bar section 304, a navigation and interactivity section 306, an appearance section 308, and a layout section 310. It should be understood that all of the settings illustrated in FIG. 3 are exemplary host settings 206, some of which may also be exemplary client settings 224. The initial size of the presentation content 220, layout settings, and whether or not the title bar/toolbar is shown are not part of the client settings 224

The presentation display section 302 includes a presentation source selection box 312 through which a user can select the presentation content 220 to be displayed in the slide view 222. In some embodiments, the presentation source selection box 312 is a drop-down menu that is pre-populated with available presentation content. In some embodiments, the user is able to input a path to the presentation content 220. The path may be, for example, a URL location of the presentation content 220, a location of the presentation content 220 within the data 118 of the server computer 110, or a location of the presentation content 220 on the client computer 102 (e.g., for upload to the server computer 110). In the illustrated embodiment, a presentation named “sample.ppt” has been selected. It should be understood that although the *.ppt file extension is illustrated, other file extensions may be used based upon the presentation file format of the presentation content 220.

The toolbar and title bar section 304 includes a show title bar checkbox 314 and a show toolbar checkbox 316. The show title bar checkbox 314 allows a user to toggle showing/hiding a title bar of the presentation. The title bar may include a file name (with or without file type extension) of the presentation selected in the presentation source selection box 312. The show toolbar checkbox 316 allows a user to toggle showing/hiding a toolbar. In the illustrated embodiment, the show title bar checkbox 314 is unchecked and the show toolbar checkbox 316 is checked.

The navigation and interactivity section 306 includes a navigation checkbox 318, auto advance radio buttons 320A, 320B, and an auto advance time selection box 322. The navigation checkbox 318 allows a user to toggle allowing/disallowing clicks, keyboard shortcuts, or other inputs used on a slide to advance a presentation. The auto advance radio buttons 320A, 320B allow a user to select whether to auto advance the presentation (i.e., selection of the auto advance radio button 320A) or respect the presentations settings, for example, settings set during the creation of the presentation for auto advance timings or manual advancement of slides (i.e., selection of the auto advance radio button 320B). The auto advance radio button 320A, when selected, allows a user to indicate a time interval between auto advancement via the auto advance time selection box 322. A time interval of two seconds is illustrated, but this should not be considered limiting in any way. In some embodiments, a “Use the default auto advance settings from the file” checkbox is alternatively or additionally presented in the settings user interface 300. When this checkbox is checked, the presentation content 220 uses any auto advance settings in the file (e.g., like a slideshow view). When this checkbox is unchecked, the presentation content 220 does not auto advance and each animation requires a click to progress through the presentation content 220 (e.g., like a reading view.)

The appearance section 308 includes height radio buttons 324A, 324B, a fixed height selection box 326, width radio buttons 328A, 328B, and a fixed width selection box 330. The height radio buttons 324A, 324B allow a user to select whether to set a fixed height for the presentation Web Part 202 or adjust the height to fit a selected zone. The height radio button 324A, when selected, allows a user to indicate a fixed height for the presentation Web Part 202 via the fixed height selection box 326. A fixed height of “360” pixels is illustrated, but this should not be considered limiting in any way. The width radio buttons 328A, 328B allow a user to select whether to set a fixed width for the presentation Web Part 202 or adjust the width to fit a selected zone. The width radio button 328A, when selected, allows a user to indicate a fixed width for the presentation Web Part 202 via the fixed width selection box 330. A fixed width of “640” pixels is illustrated, but this should not be considered limiting in any way.

The layout section 310 includes a hidden checkbox 332, a zone selection box 334, and a zone index selection box 336. The hidden checkbox 332 allows a user to toggle hidden data. The zone selection box 334 allows a user to select a zone of a Web page in which they desire to insert the presentation Web Part 202. A zone may be, for example, a header, a footer, or a body of a Web page; or may be a particular column or row within a Web page. In the illustrated embodiment, the selected zone is a middle column of a Web page. The zone index selection box 336 allows a user to select an area within a selected zone. These areas may be indicated by an integer, for example, “0” as in the illustrated embodiment. In some embodiments, the layout section 310 is automatically populated, for example, by the collaboration platform 114.

The settings user interface 300 also includes an “OK” button 338, a “CANCEL” button 340, and an “APPLY” button 342. Selection of the “OK” button 338 applies any new settings and closes the settings user interface 300. Selection of the “CANCEL” button 340 closes the settings user interface 300 without saving any new settings. Selection of the “APPLY” button 342 applies any new settings.

It is contemplated that the settings user interface 300 may not include all of the settings shown in FIG. 3, may include other settings that are not explicitly shown in FIG. 3, or may include settings completely different than those shown in FIG. 3.

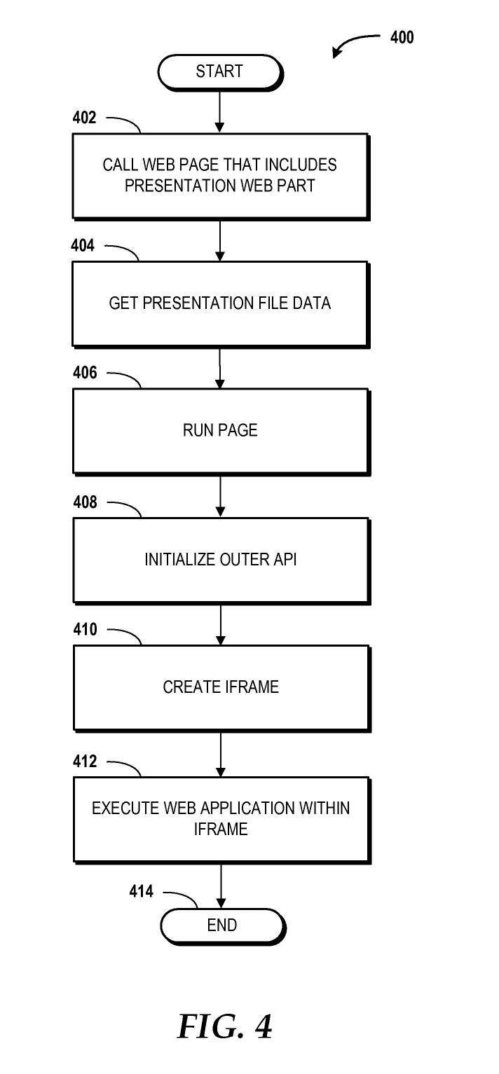

Turning now to FIG. 4, aspects of a method 400 for executing a Web page that includes a presentation Web part will be described in detail. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in its entirety. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For purposes of illustrating and describing the concepts of the present disclosure, the methods disclosed herein are described as being performed by the client computer 102 and/or the server computer 110. It should be understood that these embodiments are exemplary, and should not be viewed as being limiting in any way.

The method 400 begins in operation 402, wherein the Web browser 108 calls a Web page. This may be accomplished by the Web browser 108 receiving a URL of the Web page in a URL entry field. The URL may be input manually into the URL entry field by a user of the client computer 102, automatically upon execution of an application (e.g., a native application or a Web application), or upon selection of a hyperlink from within another Web page or a document. The Web page includes a presentation Web Part such as the presentation Web Part 202.

From operation 402, the method 400 proceeds to operation 404, wherein the Web Part 202 gets presentation file data (e.g., the presentation content 220). The source of the presentation file data may be set, for example, via the settings user interface 300 in the presentation source selection box 312. The Web browser 108 then runs the Web page in operation 406, resulting in the initialization of the outer API 208 in operation 408.

From operation 408, the method 400 proceeds to operation 410, wherein the iFrame constructor 212 (e.g., as part of the outer API 208) creates the iFrame 214. The method 400 then proceeds to operation 412, wherein a presentation Web application is executed to display the presentation content 220 within the iFrame 214. The method 400 then ends in operation 414.

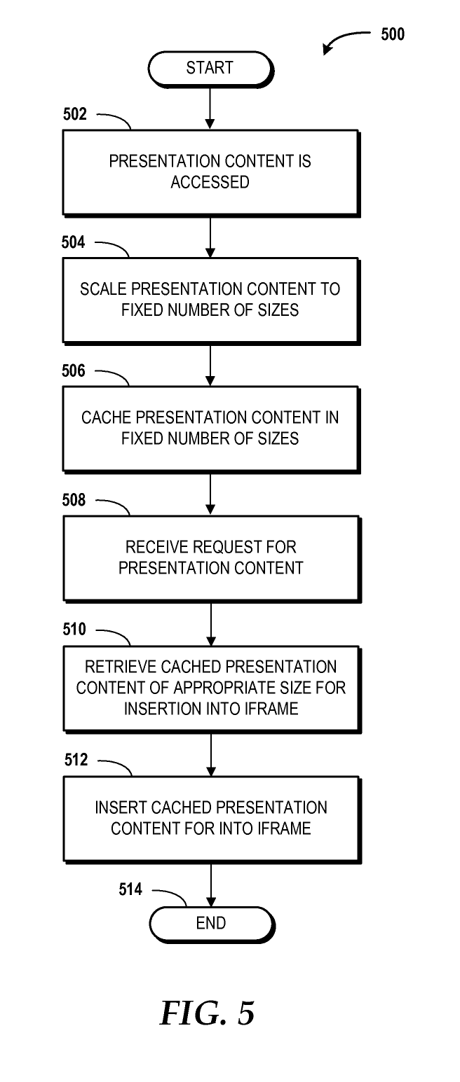

Turning now to FIG. 5, aspects of a method 500 for caching presentation content 220 will be described. The presentation content 220 may be created in various sizes (e.g., pixel dimensions) with various aspect ratios (e.g., 4:3, 16:9, 16:10, etc.). Moreover, the size of the iFrame 214 may be any size as dictated by a user. Accordingly, fitting the presentation content 220 within the iFrame 214 may result in the presentation content 220 being stretched, shrunk, or distorted in some other way; being pixelated; or being otherwise unsuitable for display within the iFrame 214. For example, the presentation content 220 in its original size may have been created for full-size display via a native or Web-based presentation viewer application and not tailored to being embedded in a Web page as part of an iFrame. The method 500 allows for caching the presentation content 220 in various sizes so that an appropriate size can be inserted into iFrames of various proportions.

The method 500 begins and proceeds to operation 502, wherein the presentation content 220 is accessed. In response to the presentation content 220 being accessed, in operation 504, the presentation content 220 is scaled to a fixed number of sizes (also referred to herein as “bundle sizes”). Although any number of sizes is contemplated, for purposes of explanation, it is assumed that the fixed number of sizes is three—small, medium, and large. The specific dimensions of each of the fixed number of sizes are not described and may be chosen based upon the needs of a particular implementation. The presentation content 220 scaled to the fixed number of sizes is referred to herein below collectively as “scaled presentation content.”

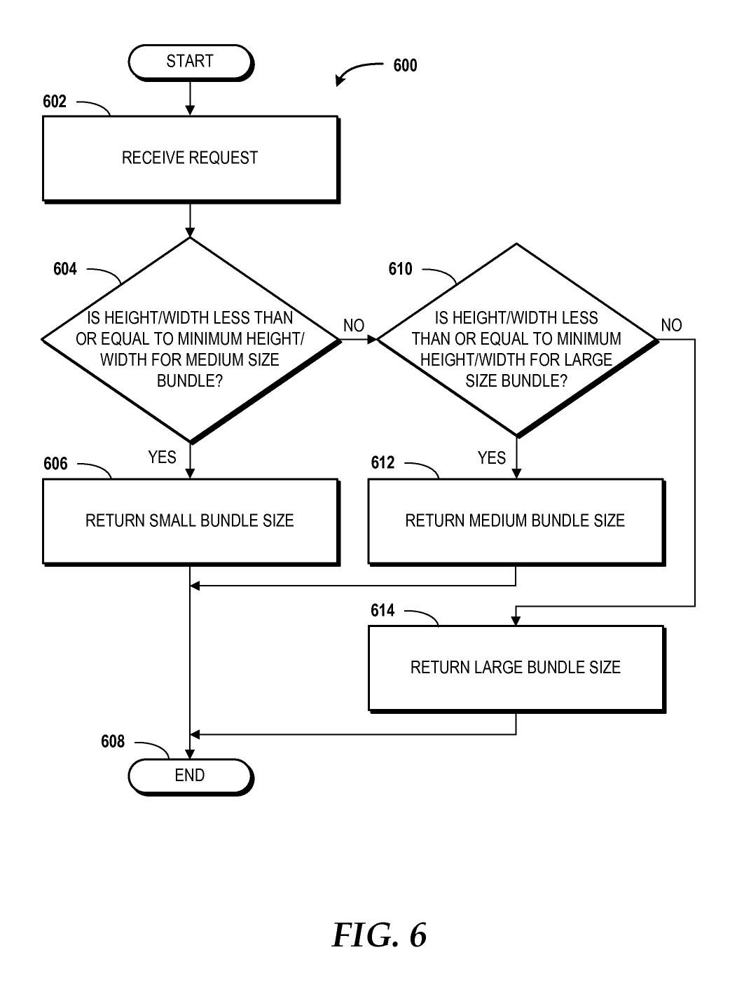

From operation 504, the method 500 proceeds to operation 506, wherein the scaled presentation content is cached for future requests for the presentation content 220. In operation 508, one such request is received and, in operation 510, the scaled presentation content is retrieved in an appropriate size (i.e., the small, medium, or large bundle size) for insertion into the Web Part 202, particularly into the iFrame 214. In some embodiments, retrieval is based upon the dimensions of the target iFrame (i.e., the iFrame 214). In some embodiments, a bundle size that is larger than the target iFrame is selected and then scaled down to fit. A method for retrieving an appropriate bundle size is illustrated and described with reference to FIG. 6.

From operation 510, the method 500 proceeds to operation 512, wherein the retrieved scaled presentation content is inserted into the iFrame 214 of the Web Part 202. The method 500 then proceeds to operation 514, wherein the method 500 ends.

Turning now to FIG. 6, aspects of a method 600 for selecting a presentation bundle size will be described. The method 600 assumes that three bundle sizes—small, medium, and large—have been defined for the presentation content 220 and cached for future requests, for example, in accordance with the method 500 described above. The method 600 begins and proceeds to operation 602, wherein a request for the presentation content to be inserted into the iFrame 214 is received.

From operation 602, the method 600 proceeds to operation 604, wherein it is determined if the height and width of the iFrame 214 is less than or equal to a minimum height and a minimum width defined for a medium size bundle. If it is determined in operation 604 that the height and width of the iFrame 214 is less than or equal to a minimum height and a minimum width defined for a medium size bundle, the method 600 proceeds to operation 606, wherein a small bundle size is selected. The method 600 then proceeds to operation 608, wherein the method 600 ends.

If, however, it is determined in operation 604 that the height and width of the iFrame 214 is not less than or equal to a minimum height and a minimum width defined for a medium size bundle, the method 600 proceeds to operation 610, wherein it is determined if the height and the width of the iFrame 214 is less than or equal to a minimum height and a minimum width defined for a large size bundle. If is determined in operation 610 that the height and the width of the iFrame 214 is less than or equal to a minimum height and a minimum width defined for a large size bundle, the method 600 proceeds to operation 612, wherein a medium bundle size is selected. The method 600 then proceeds to operation 608, wherein the method 600 ends.

If, however, it is determined in operation 610 that the height and width of the iFrame 214 is not less than or equal to a minimum height and a minimum width defined for a medium size bundle, the method 600 proceeds to operation 614, wherein a large bundle size is selected. The method 600 then proceeds to operation 608, wherein the method 600 ends.

It should be understood that the determination operations 604, 610 may separately consider the height and width components such that if either the height or the width of the iFrame 214 is less than or equal to, respectively, a minimum height or width defined for a particular size bundle, the smaller bundle size is selected (i.e., for operation 604, the small bundle size, and for operation 610, the medium bundle size). It also should be understood that more or less than three bundle size options may be defined and, as a result, more or less operations like operations 604, 610 may be used to determine if the height and/or the width of the iFrame 214 is less than or equal to a minimum height and/or a minimum width defined for a particular bundle size.

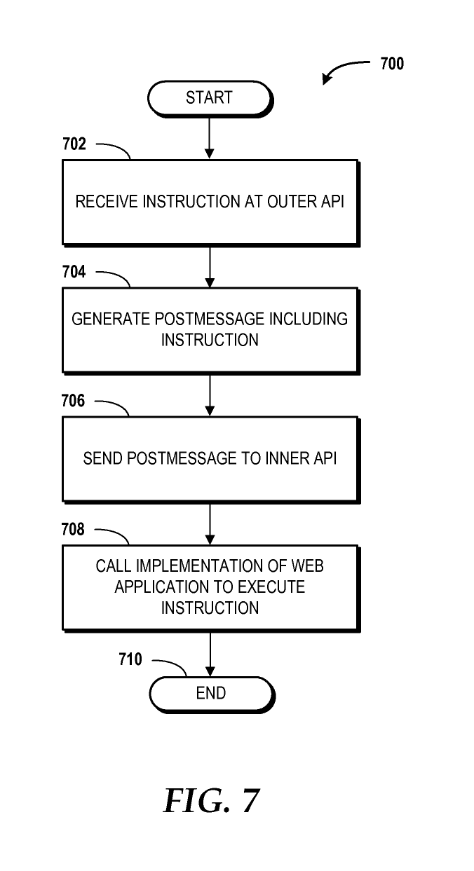

Turning now to FIG. 7, aspects of a method 700 for calling an implementation of a Web application within the Web Part 202 will be described with further reference to FIG. 2. The method 700 begins and proceeds to operation 702, wherein an instruction is received at the outer API 208. The instruction may be, for example, an instruction to advance to a next slide, return to a previous slide, end a presentation, or otherwise manipulate the presentation content 220 displayed within the iFrame 214 of the Web Part 202.

From operation 702, the method 700 proceeds to operation 704, wherein the outer API 208 generates a postMessage including the instruction received in operation 702. The method 700 then proceeds to operation 706, wherein the outer API 208 sends the postMessage to the inner API 210. From operation 706, the method 700 proceeds to operation 708, wherein the inner API 210 calls an implementation of a presentation Web application to execute the instruction included in the postMessage. The method 700 then proceeds to operation 710, wherein the method 700 ends.

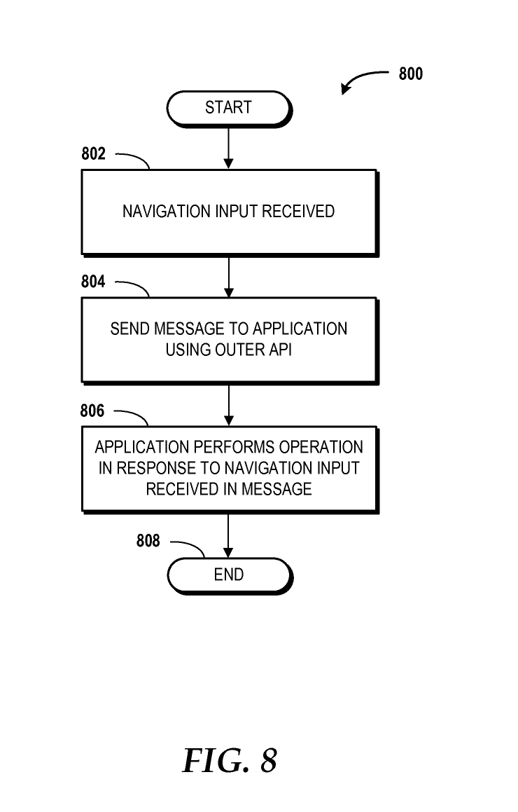

It should be understood that the outer API 208 is not limited to only sending instructions to the inner API 210 and, in turn, the viewer 216. For example, if a user navigates the viewer 216, the outer API 208 can send messages to the application that is using the outer API 208. This is illustrated and described below with reference to FIG. 8.

Turning now to FIG. 8, aspects of a method 800 for communication between the outer API 208 and an application that is calling the outer API 208 will be described with further reference to FIG. 2. The method 800 begins at operation 802, wherein a navigation input is received by the inner API 210 and is provided to the outer API 208. The outer API 208, in turn, at operation 804, sends a message including the navigation input to the application calling the outer API 208. The method 800 then proceeds to operation 806, wherein the application then performs one or more functions in response to the navigation input received in the message. The method 800 then proceeds to operation 808, wherein the method ends.

In some embodiments, the application is a map application and the navigation input is a slide advance input, such that when the navigation input is received by the application, the application, in response, manipulates the map by displaying a location that coincides with a slide displayed within the viewer 216. Other use cases are contemplated.

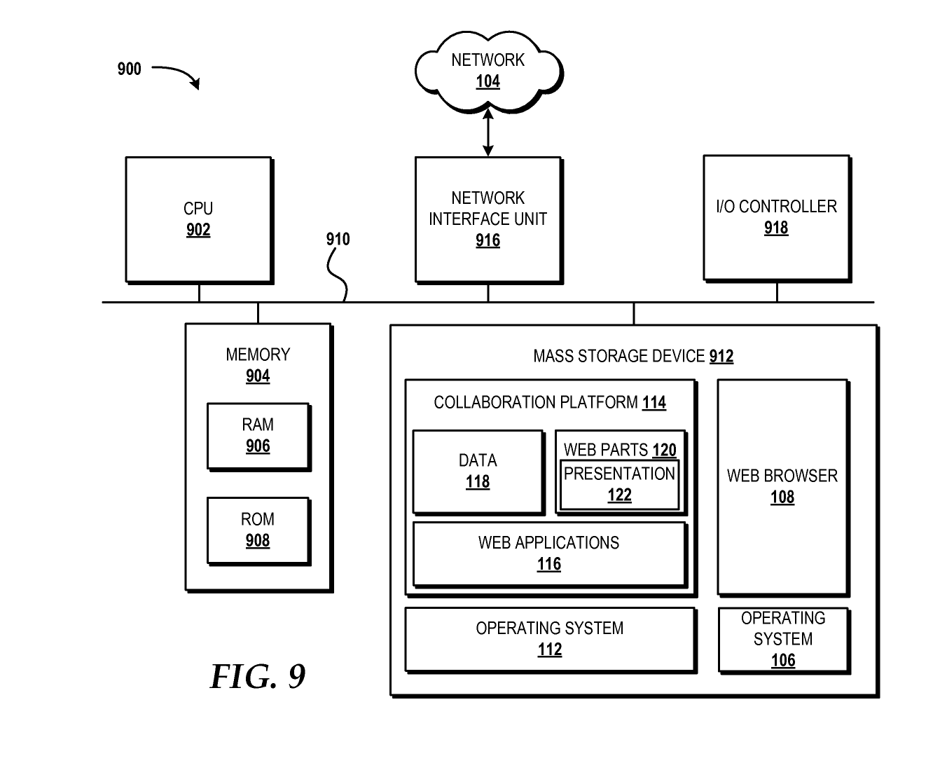

FIG. 9 illustrates an exemplary computer architecture 900 for a device capable of executing the software components described herein for embedding presentation content within a Web page utilizing a presentation Web Part. Thus, the computer architecture 900 illustrated in FIG. 9 illustrates an architecture for a server computer, mobile phone, a PDA, a smart phone, a desktop computer, a netbook computer, a tablet computer, and/or a laptop computer. The computer architecture 900 may be utilized to execute any aspects of the software components presented herein.

The computer architecture 900 illustrated in FIG. 9 includes a central processing unit 902 (“CPU”), a system memory 904, including a random access memory 906 (“RAM”) and a read-only memory (“ROM”) 908, and a system bus 910 that couples the memory 904 to the CPU 902. A basic input/output system containing the basic routines that help to transfer information between elements within the computer architecture 900, such as during startup, is stored in the ROM 908. The computer architecture 900 further includes a mass storage device 912 for storing the operating systems 106, 112, the collaboration platform 114, the web applications 116, the data 118, the Web Parts 120, the presentation Web Part 122, and the Web browser 108.

The mass storage device 912 is connected to the CPU 902 through a mass storage controller (not shown) connected to the bus 910. The mass storage device 912 and its associated computer-readable media provide non-volatile storage for the computer architecture 900. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 900.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 900. For purposes the claims, the phrase “computer storage medium” and variations thereof, does not include waves, signals, and/or other transitory and/or intangible communication media, per se.

According to various embodiments, the computer architecture 900 may operate in a networked environment using logical connections to remote computers through a network such as the network 104. The computer architecture 900 may connect to the network 104 through a network interface unit 916 connected to the bus 910. It should be appreciated that the network interface unit 916 also may be utilized to connect to other types of networks and remote computer systems, for example, remote computer systems configured to host content such as presentation content. The computer architecture 900 also may include an input/output controller 918 for receiving and processing input from a number of other devices, including a keyboard, mouse, or electronic stylus (not shown in FIG. 9). Similarly, the input/output controller 918 may provide output to a display screen, a printer, or other type of output device (also not shown in FIG. 9).

It should be appreciated that the software components described herein may, when loaded into the CPU 902 and executed, transform the CPU 902 and the overall computer architecture 900 from a general-purpose computing system into a special-purpose computing system customized to facilitate the functionality presented herein. The CPU 902 may be constructed from any number of transistors or other discrete circuit elements, which may individually or collectively assume any number of states. More specifically, the CPU 902 may operate as a finite-state machine, in response to executable instructions contained within the software modules disclosed herein. These computer-executable instructions may transform the CPU 902 by specifying how the CPU 902 transitions between states, thereby transforming the transistors or other discrete hardware elements constituting the CPU 902.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 900 in order to store and execute the software components presented herein. It also should be appreciated that the computer architecture 900 may include other types of computing devices, including hand-held computers, embedded computer systems, personal digital assistants, and other types of computing devices known to those skilled in the art. It is also contemplated that the computer architecture 900 may not include all of the components shown in FIG. 9, may include other components that are not explicitly shown in FIG. 9, or may utilize an architecture completely different than that shown in FIG. 9.

Based on the foregoing, it should be appreciated that technologies for embedding presentation content within a Web Page utilizing a presentation Web Part have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

We claim:

1. A computer storage medium having computer readable instructions stored thereupon that, when executed by a computer, cause the computer to:
create an inline frame in which to display presentation content;
execute a Web application within the inline frame; and
display the presentation content within the inline frame as a result of executing the Web application.

2. The computer storage medium of claim 1, wherein the inline frame is created by an inline frame constructor of a presentation Web Part.

3. The computer storage medium of claim 2, wherein the inline frame constructor is a function provided by an outer application programming interface, the outer application programming interface being configured to communicate with an inner application programming interface which calls the Web application for execution within the inline frame to display the presentation content.

4. The computer storage medium of claim 3, further having instructions that, when executed by the computer, cause the computer to manipulate the presentation content within the inline frame per an instruction received by the inner application programming interface from the outer application programming interface.

5. The computer storage medium of claim 4, wherein the instruction to manipulate the presentation content is an instruction to play the presentation content, stop the presentation content, select a next slide of the presentation content, select a previous slide of the presentation content, and view identifying information for a currently viewable slide of the presentation content.

6. The computer storage medium of claim 4, wherein the instruction is included in a postMessage.

7. The computer storage medium of claim 3, wherein the presentation Web Part is part of a collaboration platform.

8. The computer storage medium of claim 1, wherein the inline frame in which to display presentation content is created based upon one or more settings.

9. The computer storage medium of claim 1, wherein the inline frame comprises a viewer and wherein the instructions to display the presentation content within the inline frame comprise instructions to display the presentation content within the viewer.

10. The computer storage medium of claim 9, wherein the inline frame is associated with a user interface that is external to the inline frame and is configured to manipulate the presentation content displayed within the viewer.

11. The computer storage medium of claim 1, wherein the presentation content comprises one or more presentation slides.

12. A computer storage medium having computer readable instructions stored thereupon that, when executed by a computer, cause the computer to:
scale presentation content to a plurality of sizes;
cache the presentation content in the plurality of sizes
receive a request for the presentation content;
retrieve the presentation content in an appropriate size of the plurality of sizes for a target inline frame in which the presentation content is to be displayed; and
insert the presentation content in the appropriate size for the target inline frame.

13. The computer storage medium of claim 12, further having instructions to receive an initial request for the presentation content, and wherein scaling the presentation content to the plurality of sizes is in response to the initial request for the presentation content.

14. The computer storage medium of claim 12, wherein the appropriate size is at least one of the plurality of sizes that is less than or equal to the size of the target inline frame.

15. The computer storage medium of claim 12, further having instructions to, in response to receiving the request for the presentation content, determine if a dimension of the target inline frame is less than or equal to a minimum dimension of a first size of the plurality of sizes, to select the first size as the appropriate size if the dimension of the target inline frame is less than or equal to the minimum dimension for the first size, and to select a second size as the appropriate size if the dimension of the target inline frame is not less than or equal to the minimum dimension for the first size.

16. The computer storage medium of claim 12, further having instructions to, in response to receiving the request for the presentation content, determine if a dimension of the target inline frame is less than or equal to a first minimum dimension of a first size of the plurality of sizes, to select the first size as the appropriate size if the dimension of the target inline frame is less than or equal to the first minimum dimension for the first size, to determine if the dimension of the target inline frame is less than or equal to a second minimum dimension of a second size if the dimension of the target inline frame is not less than or equal to the first minimum dimension, to select the second size as the appropriate size if the dimension of the target inline frame is less than or equal to the second minimum dimension for the second size, and to select a third size as the appropriate size if the dimension of the target inline frame is not less than or equal to the minimum dimension for the second size.

17. The computer storage medium of claim 12, wherein the inline frame comprises a viewer in which to display the presentation content.

18. The computer storage medium of claim 12, wherein the inline frame is associated with a user interface that is external to the inline frame and is configured to manipulate the presentation content displayed within the viewer.

19. The computer storage medium of claim 12, wherein the presentation content comprises one or more presentation slides.

20. A computer storage medium having computer readable instructions stored thereupon that, when executed by a computer, cause the computer to:
display, within a Web page, an inline frame as part of a presentation Web part;
display, within the inline frame, presentation content;
receive, at an inner application programming interface, an instruction within a postMessage from an outer application programming interface, the instruction being for manipulating the presentation content within the inline frame; and
manipulate the presentation content within the inline frame in accordance with the instruction received by the inner application programming interface within the postMessage.
